(19) United States
(12) Patent Application Publication
(10) Pub. No.: US 2014/0037921 A1
(43) Pub. Date: Feb. 6, 2014

(54) OPTICAL INFORMATION RECORDING MEDIUM AND LAMINATE FOR OPTICAL INFORMATION RECORDING MEDIUM

(71) Applicant: Sony Corporation, Tokyo (JP)

(72) Inventors: Yo Ota, Tokyo (JP); Tetsuhiro Sakamoto, Kanagawa (JP); Shiori Tashiro, Kanagawa (JP); Koichi Yasuda, Kanagawa (JP); Hiroshi Uchiyama, Miyagi (JP); Mitsuaki Oyamada, Kanagawa (JP)

(73) Assignee: Sony Corporation, Tokyo (JP)

(21) Appl. No.: 13/947,639

(22) Filed: Jul. 22, 2013

(30) Foreign Application Priority Data
Aug. 3, 2012 (JP) 2012-173211

(51) Int. Cl. G11B 7/24044

(52) U.S. Cl. CPC G11B 7/24044
USPC 428/212

(57) ABSTRACT

An optical information recording medium includes multiple laminated resin layers. At least one of interfaces between the resin layers has a refractive index which gradually changes in a thickness direction of the resin layers.

### CROSS REFERENCES TO RELATED APPLICATIONS

The present application claims priority to Japanese Priority Patent Application JP 2012-173211 filed in the Japan Patent Office on Aug. 3, 2012, the entire content of which is hereby incorporated by reference.

### BACKGROUND

The present application relates to an optical information recording medium and a laminate for use in an optical information recording medium. More specifically, it relates to an optical information recording medium on which a recording mark can be formed by radiating light thereto.

The compact disc (CD), the digital versatile disc (DVD), the Blu-ray Disc®, and the like have been widely used as optical information recording media. On the other hand, with the conversion of televisions into high-definition specs or with rapid increases in the amount of data handled by personal computers (PCs), optical information recording media have been desired to have larger capacities in recent years.

Under the circumstances, a method of three-dimensionally recording information in the thickness direction of an optical information recording medium has been proposed as one of methods for increasing the capacity of an optical information recording medium. One of optical information recording media which employ such a method is an optical information recording medium that employs a method of previously containing, in a recording layer, a recording material which foams when absorbing photons and of radiating a light beam to form a void serving as a recording mark (hereafter referred to as “the void recording method”) (for example, see Japanese Unexamined Patent Application Publication No. 2008-176902).

However, since the void recording method forms a void as a recording mark as described above, it has to use very high laser power to record an information signal. For this reason, there has been proposed a method of forming a recording mark on any one of interfaces between laminated multiple resin layers to reduce laser power which has to be used to record an information signal (hereafter referred to as “the interface recording method”) (for example, see Japanese Unexamined Patent Application Publication No. 2011-86327).

### SUMMARY

For the interface recording method, however, when a resin layer has a thickness which is appropriately equal to a wavelength, the effect of interference between regeneration light or recording light reflected from the upper (incident) interface of the resin layer and regeneration light or recording light reflected from the lower (back) interface thereof becomes remarkable. This is because the effect of interference of light converged or diverged by a lens becomes larger as the optical path difference between the light reflected from each interface becomes smaller. To suppress such effect of interference, the thickness of the resin layers has to be controlled precisely. Precise control of the film thickness involves a high resin layer formation technology, resulting in increases in manufacturing cost.

Accordingly, it is desirable to provide an optical information recording medium and a laminate for use in an optical information recording medium that can suppress interference between regeneration light or recording light reflected from two or more adjacent interfaces without having to precisely control the thickness.

An optical information recording medium according to a first embodiment of the present application includes a plurality of laminated resin layers. At least one of interfaces between the resin layers has a refractive index which gradually changes in a thickness direction of the resin layers.

A laminate for use in an optical information recording medium according to a second embodiment of the present application includes a plurality of laminated resin layers. Interfaces between the resin layers are configured such that a recording mark can be formed thereon. At least one of the interfaces between the resin layers has a refractive index which gradually changes in a thickness direction of the resin layers.

According to the present application, it is possible to suppress reflection of regeneration light or recording light from the interfaces having a refractive index which gradually changes in the thickness direction of the resin layers. As a result, it is possible to suppress interference between regeneration light or recording light caused by interface reflection without having to control the thickness of the resin layers.

As described above, according to the present application, it is possible to suppress interference between regeneration light or recording light caused by interface reflection without having to precisely control the thickness of the resin layers.

Additional features and advantages are described herein, and will be apparent from the following Detailed Description and the figures.

### BRIEF DESCRIPTION OF THE FIGURES

FIG. 1 is a schematic sectional view showing one example configuration of an optical information recording medium according to a first embodiment of the present application;

FIG. 2 is a schematic sectional view showing an example configuration of a bulk layer;

FIGS. 3A to 3C are process diagrams showing an example of a method for manufacturing the optical information recording medium according to the first embodiment of the present application;

FIGS. 4A to 4C are process diagrams showing an example of a method for manufacturing the optical information recording medium according to the first embodiment of the present application;

FIG. 5 is a schematic sectional view showing another example configuration of the optical information recording medium according to the first embodiment of the present application;

FIGS. 6A to 6C are process diagrams showing an example of a method for manufacturing an optical information recording medium according to a second embodiment of the present application;

FIG. 7 is a schematic diagram showing an example of a method for forming a bulk layer;

FIG. 8 is a diagram showing a simulation model of Test Example 1;

FIGS. 9A to 9C are diagrams showing simulation models of Test Examples 2-1 to 2-3;

FIGS. 10A to 10C are diagrams showing simulation models of Test Examples 3-1 to 3-3;

FIGS. 11A to 11C are diagrams showing simulation models of Test Examples 4-1 to 4-3;

FIGS. 12A to 12D are diagrams showing simulation models of Test Examples 5-1 to 5-4;

FIGS. 13A to 13D are graphs showing simulation models of Test Example 5-5;

FIGS. 14A to 14D are process diagrams showing an example of a method for manufacturing an optical information recording medium according to a third embodiment of the present application; and

FIGS. 15A to 15C are process diagrams showing an example of the method for manufacturing the optical information recording medium according to the third embodiment of the present application.

### DETAILED DESCRIPTION

Now, embodiments of the present application will be described in the following order with reference to the accompanying drawings.

1. First embodiment (an example of an optical information recording medium for recording an information signal on an interface)
2. Second embodiment (an example of a manufacturing method using a roll-to-roll process)
3. Third embodiment (an example of a manufacturing method using ultraviolet radiation)

### 1. First Embodiment

### Configuration of Optical Information Recording Medium

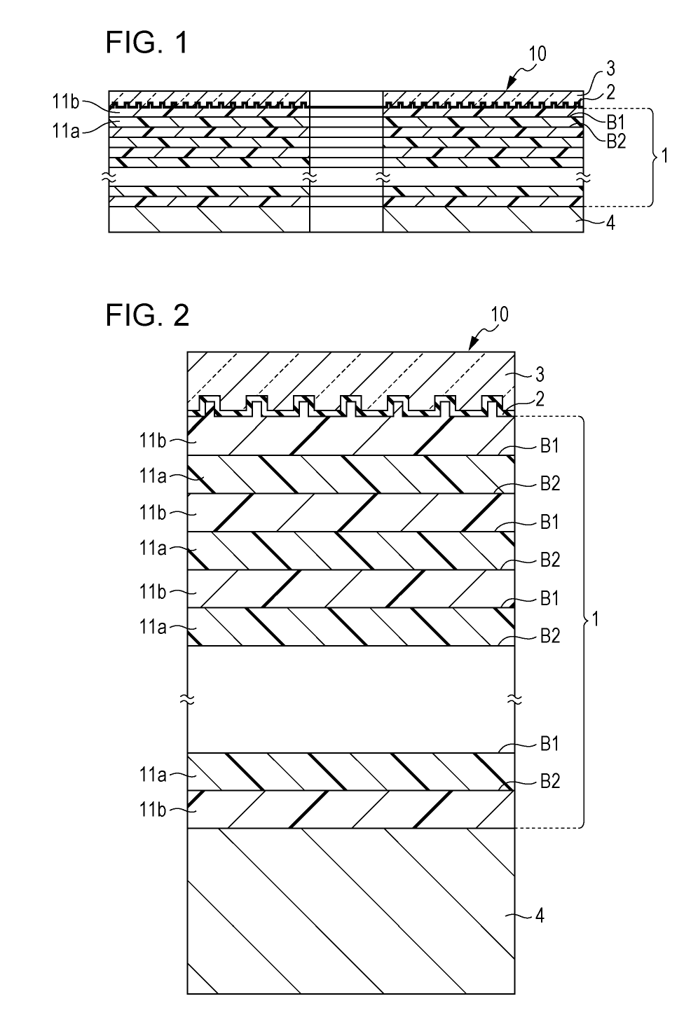

FIG. 1 is a schematic sectional view showing an example configuration of an optical information recording medium according to the first embodiment of the present application. As shown in FIG. 1, an optical information recording medium 10 includes a bulk layer 1, a selection reflective layer 2 disposed on the bulk layer 1, and a cover layer 3 disposed on the selection reflective layer 2. The optical information recording medium 10 may be further provided with a substrate 4 on a surface thereof opposite to the cover layer 3. The optical information recording medium 10 as a whole is in the form of an appropriate disc and has an aperture for chucking in the center thereof (hereafter referred to as the center hole).

With the optical information recording medium 10 according to the first embodiment being driven rotationally, a laser beam is radiated to interfaces B in the bulk layer 1 from the surface thereof adjacent to the cover layer 3 to record or regenerate an information signal. Hereafter, the surface on which a laser beam is incident will be referred to as the incident surface, and the surface opposite to the incident surface as the back surface.

The cover layer 3, the selection reflective layer 2, the bulk layer 1, and the substrate 4 forming the optical information recording medium 10 will be described in turn.

Cover Layer

The cover layer 3 may be made of any material as long as the material is transparent. For example, it may be made of an organic material, such as a transparent plastic material, or an inorganic material, such as glass. Examples of a plastic material include existing polymeric materials. Examples of the existing polymeric materials include polycarbonate (PC), acrylic resin (PMMA), cyclo olefin polymer (COP), triacetylcellulose (TAC), polyester (TPEE), polyethylene terephthalate (PET), polyethylene naphthalate (PEN), polyimide (PI), polyamide(PA), aramid, polyethylene (PE), polyacrylate, polyether sulfone, polysulfone, polypropylene (PP), diacetyl cellulose, polyvinyl chloride, epoxy resins, urea resins, urethane resins, and melamine resins. Examples of an inorganic material include quartz, sapphire, and glass.

The cover layer 3 is, for example, in the form of an appropriate disc having a center hole in the center thereof. One principal surface of the cover layer 3 is, for example, a corrugated surface, and the selection reflective layer 2 is disposed on the corrugated surface. The corrugated surface has guide grooves for guiding the recording or reproduction position. Examples of the overall shape of the guide grooves when seen from the principal surface of the optical information recording medium 10 include various shapes, such as a spiral and a concentric circle.

Examples of the guide grooves include continuous grooves, pit trains, and combinations thereof. To stabilize the linear velocity or add position information (for example, rotational angle information, radius position information, etc.), the guide grooves may be meandered.

Selection Reflective Layer

The selection reflective layer 2 is disposed on the corrugated surface of the cover layer 3. In the optical information recording medium 10, recording light for recording a mark on the bulk layer 1 (a first laser beam), as well as servo light for obtaining a tracking error signal or focus error signal on the basis of the guide grooves of the cover layer 3 (a second laser beam) are radiated to the selection reflective layer 2. When the selection reflective layer reflects or absorbs the recording light radiated, the amount of recording light which reaches the inside of the bulk layer 1 decreases, resulting in a reduction in the apparent recording sensitivity. For this reason, the selection reflective layer 2 is preferably a reflective layer having selection characteristics of reflecting servo light but transmitting almost all recording light.

In the optical information recording medium 10, recording light and servo light are, for example, laser beams of different wavelengths. Examples of the selection reflective layer 2 include a selection reflective layer having wavelength selection characteristics of reflecting light in the same wavelength range as servo light but transmitting light (for example, recording light) in other wavelength ranges.

Examples of the selection reflective layer 2 having such wavelength selection characteristics include a multilayer film in which low-refractive-index layers and high-refractive-index layers, which have different refractive indexes, are alternately laminated. Examples of low-refractive-index and high-refractive-index layers include dielectric layers. Examples of the material of dielectric layers include silicon nitride, silicon oxide, tantalum oxide, titanium oxide, magnesium fluoride and zinc oxide.

Bulk Layer

The bulk layer 1 is a laminate in which multiple resin layers are laminated (a laminate for use in an optical information recording medium), and interfaces are formed between the resin layers. The bulk layer 1 is configured such that an information mark can be formed on any one of the interfaces between the resin layers. The adjacent resin layers have, for example, different refractive indexes. At least one of the interfaces between the resin layers has a refractive index which gradually changes in the thickness direction of the resin layers. To reduce the reflectance of regeneration light or recording light and to increase the transmittance thereof, such changes in refractive index are preferably continuous changes and more preferably changes such that the refractive index of one of resin layers forming an interface is tilted toward the refractive index of the other resin layer.

Assuming that every adjacent two interfaces of the interfaces in the bulk layer 1 form a single set, one of interfaces forming a single set preferably has a refractive index which continuously changes in the thickness of the resin layers, while the other interface preferably has a refractive index which discontinuously changes in such a direction. Thus, it is possible to suppress multiple interference between recording light or regeneration light reflected from interfaces forming one set. If the above interface configuration is employed, a recording mark is formed, for example, on an interface having a refractive index which changes discontinuously.

More specifically, as shown in FIG. 1, the bulk layer 1 is a laminate in which multiple resin layers 11a and multiple resin layers 11b are laminated (a laminate for use in an optical information recording medium). An interface B1 is formed between a resin layer 11a and a resin layer 11b which are laminated in this order, and an interface B2 is formed between the resin layer 11b and a resin layer 11a which are laminated in this order. The bulk layer 1 is configured such that an information mark can be formed, for example, on any interface B1. Adjacent resin layers, 11a and 11b, have, for example, different refractive indexes. The interface B1 has, for example, a refractive index which gradually changes in the thickness direction from the resin layer 11a toward the resin layer 11b. To reduce the reflectance of regeneration light or recording light and to increase the transmittance thereof, the gradual changes in refractive index are preferably continuous changes and more preferably changes such that the refractive index of one, 11a, of resin layers forming an interface is tilted toward the refractive index of the other resin layer, 11b. The width of the transition region in which the refractive index gradually changes, in the interface B1 is preferably about 100 nm or more and about 1 μm or less.

If at least one of the resin layers 11a and resin layers 11b in the bulk layer 1 has a small thickness such that condensed recording light or regeneration light can interfere in the wavelength (about 5 μm or less), the interfaces B1 preferably have a refractive index which continuously changes in the thickness direction of the recording layers 11, while the interfaces B2 preferably has a refractive index which discontinuously changes in such a direction. Thus, it is possible to suppress multiple interference between recording light or regeneration light reflected from adjacent interfaces, B1 and B2. If the above configuration of the interfaces B is employed, a recording mark is formed, for example, on any interface B2 having a refractive index which changes discontinuously.

Two resin layers, 11a and 11b, forming an interface having a gradually changing refractive index are preferably mutually dissolved in the interface. As used herein, the “mutually dissolved” means that the material composition of the two resin layers, 11a and 11b, continuously changes in the transition region having a width of about 100 nm or more in the thickness direction from 11a toward 11b. Thus, it is possible to gradually change the refractive index of the interface between the resin layers 11a and 11b in the thickness direction.

FIG. 2 is a sectional view showing an example configuration of the bulk layer. As shown in FIG. 2, the bulk layer 1 is a laminate in which multiple recording layers 11a serving as first resin layers and intermediate layers 11b serving as second resin layers are alternately laminated. The bulk layer 1 has the multiple first interfaces B1 and multiple second interfaces B2 formed by the recording layers 11a and intermediate layers 11b. A first interface B1 is formed by a recording layer 11a and an intermediate layer 11b adjacent to the incident surface of the recording layer 11a; a second interface B2 is formed by the recording layer 11a and an intermediate layer 11b adjacent to the back surface of the recording layer 11a. One of the first interface B1 and the second interface B2 preferably has a continuously changing refractive index; the other interface preferably has a discontinuously changing refractive index. Thus, it is possible to suppress the effect of interference between recording light or regeneration light reflected from the first interface B1 and from the second interface B2. If the configuration of the first interface B1 and the second interface B2 is employed, a recording mark is formed, for example, on any interface having a discontinuously changing refractive index, of the first interfaces B1 and the second interfaces B2.

The average thickness of the recording layers 11a is preferably 30 nm or more and 5 μm or less, more preferably 30 nm or more and 1 μm or less. When the average thickness of the recording lights 11a is 5 μm or less and in particular 1 μm or less, the effect of interference between light reflected from the interface B1 adjacent to the incident surface of the recording layer 11a and light reflected from the interface B2 adjacent to the back surface thereof tends to be at a non-negligible level. On the other hand, when the average thickness of the recording layers 11a exceeds 5 μm, the effect of interference between light reflected from the interface B1 adjacent to the incident surface of the recording layer 11a and light reflected from the interface B2 adjacent to the back surface thereof tends to be at a negligible level, that is, at a level such that the effect can be isolated as a focus error signal.

For example, if regeneration light having a wavelength of 405 nm is used and the refractive index of the recording layers 11a is set to 1.3 to 1.8, the thickness at which apparent reflected light is maximized by an optical enhancement effect caused by interference is about 80 nm at a refractive index n of 1.3 and about 55 nm at a refractive index n of 1.8. For this reason, if the thickness of a thin film is smaller than 30 nm, which is about half the thickness when the refractive index n is 1.8, any optical interference between the front and back surfaces thereof does not have to be considered. As a result, any measure as discussed in the present application does not have to be taken. Accordingly, the lower limit of the average thickness of the recording layers 11a is preferably set to 30 nm.

The average thickness of the recording layers 11a refers to the average distance between the first interfaces B1 and the second interfaces B2. If, in one of these interfaces, the materials of the recording layer 11a and the intermediate layer 11b forming that interface are mutually dissolved, the position of that interface is defined as follows. That is, if the composition of the material of the recording layer 11a is represented by A and the composition of the material of the intermediate layer 11b is represented by B, the position at which the composition B is averagely 90 mol % is defined as the position of that interface.

The materials of the recording layer 11a and the intermediate layer 11b are, for example, materials having different refractive indexes. Examples of the materials of the recording layer 11a and the intermediate layer 11b include organic materials and organic-inorganic composite materials. At least one of the recording layers 11a and the intermediate layers 11b may contain an additive, as necessary. If at least one of the recording layers 11a and the intermediate layers 11b contains an additive, the refractive index of the interfaces B1 or interfaces B2 may be gradually changed by changing the concentration of the additive in the interfaces B1 or interfaces B2.

Examples of an organic material include at least one selected from the group consisting of a thermoplastic resin, a thermosetting resin, an energy beam-curable resin, and the like.

Examples of a thermoplastic resin include aromatic polyesters, such as polyethylene terephthalate, polyethylene2,6-naphthalene, and polybutylene terephthalate, and polyolefins, such as polyethylene and polypropylene. Alternatives include polyvinyls, such as polystyrene, polyamides, such as nylon66(poly(hexamethylenediamine-co-adipic acid)), and aromatic polycarbonates, such as bisphenol A polycarbonate. Other alternatives include homopolymers, such as poly sulfone, resins containing a copolymer of homopolymers as a main ingredient, and fluororesins. Yet other alternatives include mixtures of the resins exemplified.

Examples of a thermosetting resin include phenol resins, melamine resins, urea resins, and epoxy resins. In particular, epoxy-terminated resins are preferred in terms of flexibility (for example, optical design, light absorption function, or the like).

An energy beam-curable resin is a resin which can be cured by radiating an energy beam thereto. As used herein, the energy beam refers to an energy beam that can trigger polymerization reaction, such as radical polymerization, cation polymerization, or anion polymerization. Examples thereof include an electron beam, an ultraviolet ray, an infrared ray, a laser beam, a visible ray, ionizing radiation (x-ray, α-ray, β-ray, γ-ray, etc.), a microwave, and a high-frequency wave. An organic-inorganic composite material may be used as an energy beam-curable resin composition. Alternatively, a mixture of two or more energy beam-curable resin compositions may be used. A preferred energy beam-curable resin composition is an ultraviolet-curable resin.

Examples of an ultraviolet-curable resin include compounds containing one or more (meta)acryloyl groups. As used herein, the (meta)acryloyl group refers to an acryloyl group or metaacryloyl group. Specific examples of an ultraviolet-curable resin include an ultraviolet-curable resin formed by preparing any amount of monomer from the ARONIX series available from Toagosei Co., Ltd. Examples of a monofunctional monomer of an ultraviolet-curable resin include isobutyl acrylate, t-butyl acrylate, iso-octyl acrylate, lauryl acrylate, stearyl acrylate, and the like available from Osaka Gas Chemicals Co., Ltd. Even when there are used resin materials that differ in surface nature (surface tension) due to inclusion of elemental fluorine or elemental sulfur, it is possible to mutually dissolve the resin materials in the first interfaces B1 or second interfaces B2 to gradually change the refractive index in the transition region of the first interfaces B1 or second interfaces B2 in the film thickness direction.

Examples of an organic-inorganic composite material include nanocomposites formed by combining an organic material and an inorganic material at a nano level. The refractive index of the interface B1 or interface B2 may be gradually changed by a preparing a nanocomposite material composition.

An Information signal is recorded on the optical information recording medium 10 thus configured as follows. That is, when a recording layer 11a absorbs a laser beam, it generates heat and becomes deformed (for example, thermally expands and becomes convex) using the heat. An adjacent intermediate layer 11b then imitates the deformation, so that the interface between these layers deforms itself from a flat surface to a curved surface. Thus, a recording mark (phase pit) is formed. The position in which recording is performed by focusing a laser beam is preferably a position which is slightly closer to the recording layer 11a than the interface, but not limited to such a position. For example, the position in which recording is performed by focusing a laser beam may be a position which is slightly closer to the intermediate layer 11b than the interface.

Substrate

The cover layer 4 is, for example, in the form of an appropriate disc having a center hole in the center thereof. The material of the substrate 4 may be any of a transparent material and an opaque material and may be, for example, a plastic material or glass. A plastic material is preferred in terms of formability. Examples of a plastic material include polycarbonate resins, polyolefin resins, and acrylic resins. Polycarbonate resins are preferred in terms of cost.

Method for Manufacturing Optical Information Recording Medium

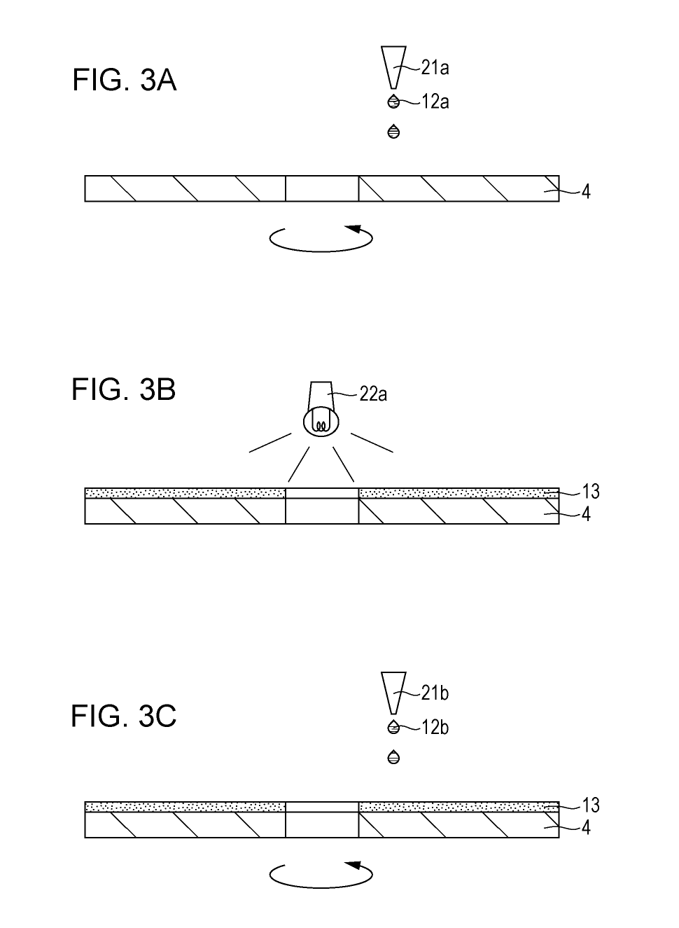

Referring now to FIGS. 3A to 3C, there will be described an example of a method for manufacturing the optical information recording medium 10 according to the first embodiment of the present application.

First Coating Process

First, as shown in FIG. 3A, a first resin composition 12a is dropped on the inside radius of a substrate 4 using an applicator 21a, and the first resin composition 12a dropped is stretched in the circumferential direction of the substrate 4 by spin coat to form a coating having a uniform thickness on the substrate 4. Examples of the first resin composition 12a include thermosetting resins and ultraviolet-curable resins. The resin composition that can be used in the present manufacturing method is not limited to these and may be an energy beam-curable resin, thermoplastic resin, or the like other than ultraviolet-curable resins, as described above.

Semi-Curing Process

Next, as shown in FIG. 3B, the coating formed on the substrate 4 is semi-cured by radiating an infrared ray or ultraviolet ray from a radiation source 22a. Thus, a semi-cured film 13 having a uniform thickness is formed on the substrate 4. Examples of the radiation source 22a for infrared radiation include IR lamps, and examples of the radiation source 22a for ultraviolet radiation include UV lamps.

If a thermosetting resin is used as the first resin composition 12a, the coating can be semi-cured by adjusting the infrared radiation time or post-radiation wait time. If an ultraviolet-curable resin is used as the first resin composition 12a, the coating can be semi-cured by adjusting the ultraviolet dose (the cumulative amount of light). The ultraviolet dose is preferably set to 80% or less of the dose when completely curing the coating.

Second Coating Process

Next, as shown in FIG. 3C, a second resin composition 12b is dropped on the inside radius of the substrate 4 using an applicator 21b, and the second resin composition 12b dropped is stretched in the circumferential direction of the substrate 4 by spin coat to form a coating having a uniform thickness on the semi-cured film 13. Examples of the second resin composition 12b include thermosetting resins and ultraviolet-curable resins. The resin composition that can be used in the present manufacturing method is not limited to these and may be an energy beam-curable resin, thermoplastic resin, or the like other than ultraviolet-curable resins, as described above.

Completely Curing Process

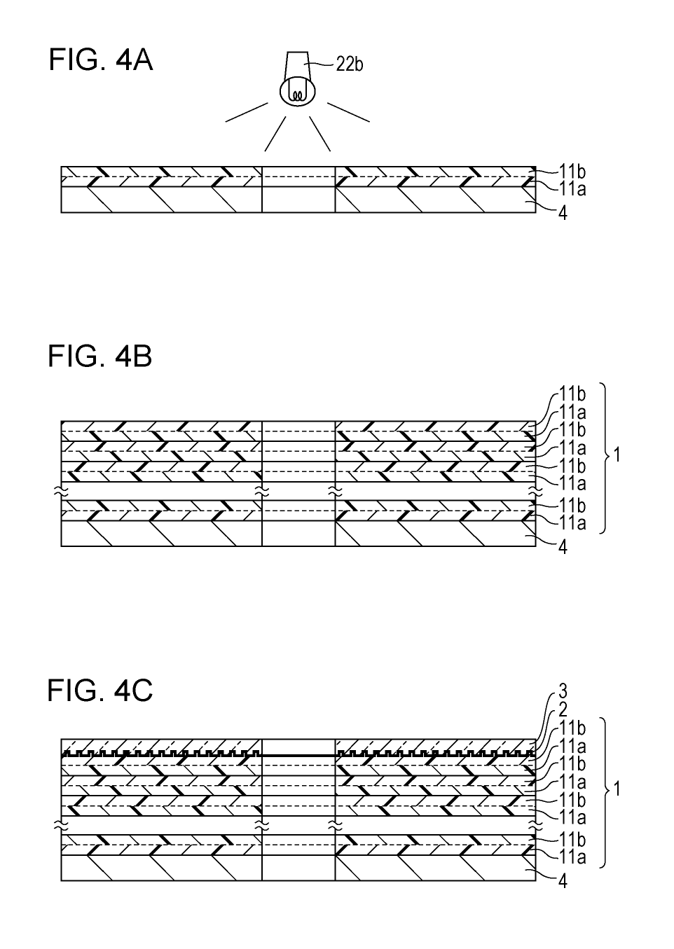

Next, as shown in FIG. 4A, by radiating an infrared ray or ultraviolet ray from a radiation source 22b, the coating made of the second resin composition 12b formed on the semi-cured film 13, as well as the semi-cured film 13 made of the first resin composition 12a are completely cured. Thus, a recording layer 11a and an intermediate layer 11b are formed on the substrate 4. At this time, an interface B1 having a gradually changing refractive index is formed between the first resin composition 12a and the second resin composition 12b. Examples of the radiation source 22b for infrared radiation include IR lamps, and examples of the radiation source 22B for ultraviolet radiation include UV lamps.

Lamination Process

Next, the processes from “the first coating process” to “the completely curing process” are repeated multiple times. Thus, as shown in FIG. 4B, multiple recording layers 11a and multiple intermediate layers 11b are alternately laminated, forming a bulk layer 1 on the substrate 4. At this time, an interface B1 having a gradually changing refractive index is formed between a recording layer 11a and an intermediate layer 11b, and an interface B2 having a discontinuously changing refractive index is formed between the intermediate layer 11b and another recording layer 11a.

Next, as shown in FIG. 4C, a cover layer 3 having a selection reflective layer 2 thereon is bonded to one principal surface of the bulk layer 1 formed on the substrate 4. Thus, the desired optical information recording medium 10 is obtained.

Effects

According to the first embodiment, it is possible to suppress reflection of recording light or regeneration light from the interface B1 having a refractive index which continuously changes in the thickness direction of the intermediate layer 11b formed on the recording layer 11a. As a result, it is possible to suppress the effect of interference between light reflected from the upper and lower interfaces of any resin layer 11b without having to precisely control the thickness of the resin layers 11b. Further, it is possible to form a recording mark on any one of the interfaces B2, which are formed between the multiple resin layers 11b and the resin layers 11a formed on the resin layers 11b and which have a discontinuously changing refractive index. Thus, it is possible to detect whether the recording mark exists, by radiating regeneration light to the interfaces B2 and using optical feedback thereof as a regeneration signal.

By continuously changing the refractive index of one of a first interface B1 and a second interface B2 formed on both sides of a recording layer 11 and, on the other hand, by discontinuously changing the refractive index of the other interface, it is possible to suppress interference between light reflected from the first interface B1 and from the second interface B2.

Modification

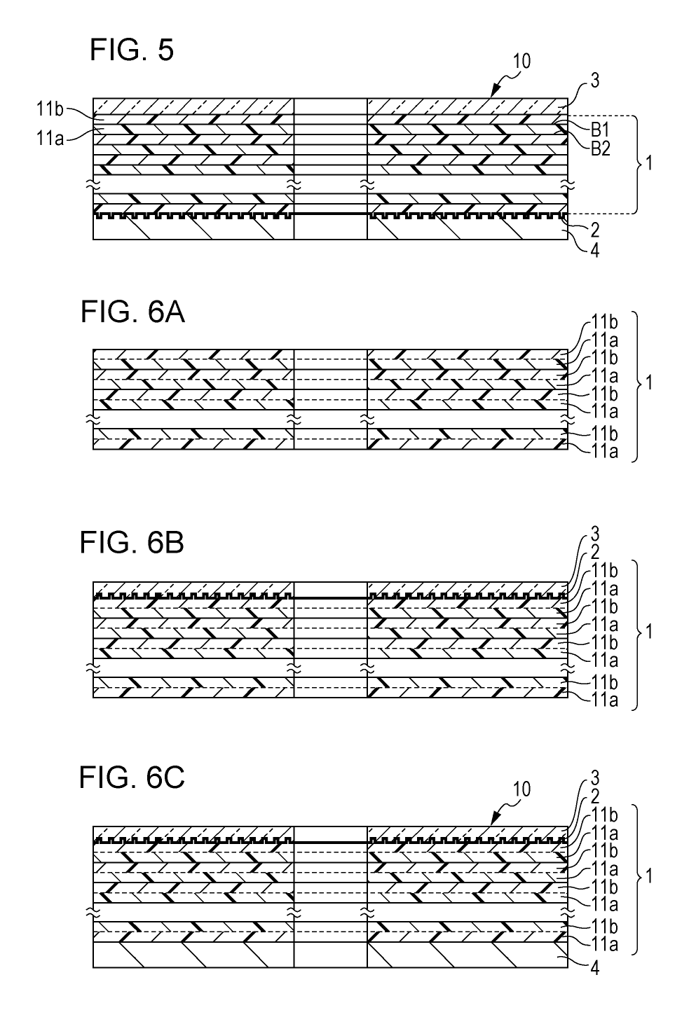

FIG. 5 is a schematic sectional view showing another example configuration of the optical information recording medium according to the first embodiment of the present application. As shown in FIG. 5, the optical information recording medium 10 may have a multilayer structure in which the selection reflective layer 2, the bulk layer 1, and the cover layer 3 are laminated on one principal surface of the substrate 4 in this order. In this configuration, the principal surface of the substrate 4 is formed into a corrugated surface serving as guide grooves for guiding the recording position or regeneration position.

Preferably, the selection reflective layer 2 reflects servo light efficiently and suppresses reflection of recording light. A purpose for suppressing reflection of recording light is to prevent stray light reflected from the selection reflective layer 2 from affecting a recording operation. Examples of the selection reflective layer 2 thus configured include the above multilayer film, in which the multiple low-refractive-index layers and multiple high-refractive-index layers are alternately laminated, as well as alloy thin films made of Ag, Cu, Au, or the like and thin films made of titanium nitride or the like.

### Second Embodiment

Referring now to FIGS. 6A to 6C, there will be described an example of a method for manufacturing an optical information recording medium 10 according to a second embodiment of the present application.

First, as shown in FIG. 6A, there is formed a bulk layer 1 (a laminate for use in an optical information recording medium) in which multiple recording layers 11a and multiple intermediate layers 11b are alternately laminated. The bulk layer 1 is formed, for example, by stamping a belt-shaped multilayer film (a laminate for use in an optical information recording medium) into a disc shape. Details of the method for forming the bulk layer 1 will be described later.

Next, as shown in FIG. 6B, a cover layer 3 having a selection reflective layer 2 thereon is bonded to one principal surface of the bulk layer 1 via a bond. Examples of a bond include photosensitive resins, such as ultraviolet-curable resins, and pressure-sensitive adhesives (PSAs).

Next, as shown in FIG. 6C, a substrate 4 is bonded to the other principal surface of the bulk layer 1 via a bond, as necessary. Examples of a bond include photosensitive resins, such as ultraviolet-curable resins, and pressure-sensitive adhesives. Thus, the desired optical information recording medium 10 is obtained.

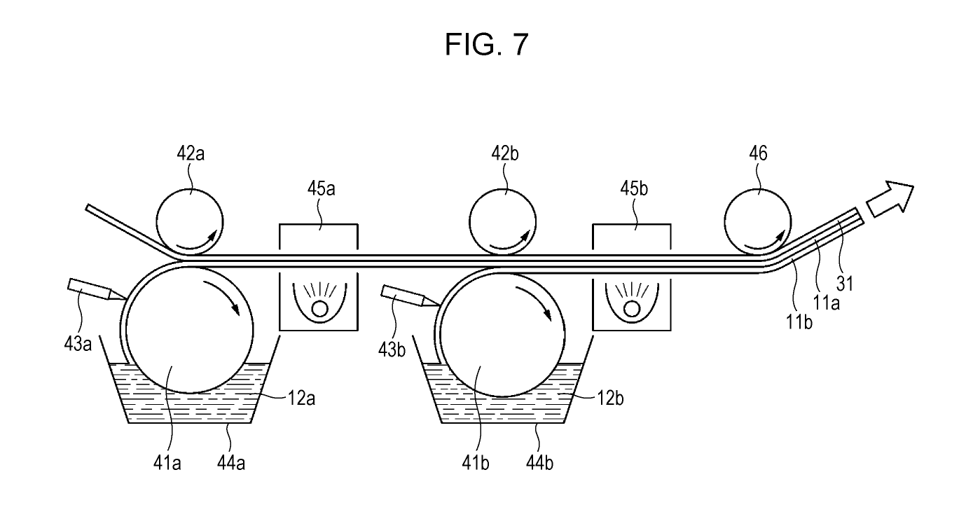

Referring now to FIG. 7, an example of the method for forming a bulk layer will be described.

First Coating Process

First, a coating roll 41a is partially immersed in a first resin composition 12a reserved in a reservoir 44a and then rotated to pull up the first resin composition 12a with the surface of the coating roll 41a. Next, an excess portion of the first resin composition 12a pulled up with the surface of the coating roll 41a is scraped off using a doctor blade 43a. Next, a protective sheet 31 is interposed between a pressure roll 42a and the coating roll 41a and pressed against the coating roll 41a by the pressure roll 42a so that the first resin composition 12a is uniformly transferred to the protective sheet 31. Thus, a uniform coating is formed on a surface of the protective sheet 31. Note that there may be employed a configuration in which a recording sheet is previously disposed on the coating surface of the protective sheet 31. Resin layers 11a and 11b forming the recording sheet have similar functions and materials to those of the above resin layers 11a and 11b used when forming a laminate by spin coat.

Semi-Curing Process

Next, the protective sheet 31 is transferred to a semi-curing unit 45a to semi-cure the coating formed on the protective sheet 31. Thus, a uniform semi-cured layer is formed on the surface of the protective sheet 31. The semi-curing unit 45a is, for example, a unit configured to radiate an ultraviolet ray or infrared ray. If the first resin composition is an ultraviolet-curable resin, the semi-curing unit 45a may be, for example, a UV radiation unit. If the first resin composition is a thermosetting resin, the semi-curing unit 45a may be, for example, a dryer (heater).

If a thermosetting resin is used as the first resin composition 12a, the coating can be semi-cured by adjusting the infrared radiation time and post-radiation wait time. If an ultraviolet-curable resin is used as the first resin composition 12a, the coating can be semi-cured by adjusting the ultraviolet dose (the cumulative amount of light). The ultraviolet dose is preferably set to 80% or less of the dose when completely curing the coating.

Second Coating Process

Next, a coating roll 41b is partially immersed in a second resin composition 12b reserved in a reservoir 44b and then rotated to pull up the second resin composition 12b with the surface of the coating roll 41b. Next, an excess portion of the second resin composition 12b pulled up with the surface of the coating roll 41b is scraped off using a doctor blade 43b. Next, the protective sheet 31 is interposed between a pressure roll 42b and the coating roll 41b and then pressed against the coating roll 41a by the pressure roll 42a so that the second resin composition 12a is uniformly transferred to the protective sheet 31. Thus, a uniform coating is formed on the surface of the semi-cured layer.

Completely Curing Process

Next, the protective sheet 31 is transferred to a curing unit 45b to cure the coating formed on the semi-cured layer, as well as to completely cure the semi-cured layer. Thus, a recording layer 11a and an intermediate layer 11b are formed on the surface of the protective sheet 31. The curing unit 45b is, for example, a unit configured to radiate an ultraviolet ray or infrared ray. If the second resin composition is an ultraviolet-curable resin, the curing unit 45b may be, for example, a UV radiation unit. If the second resin composition is a thermosetting resin, the curing unit 45b may be, for example, a dryer (heater).

Lamination Process

Next, the protective sheet 31 having the recording layer 11a and the intermediate layer 11b thereon is transferred to a subsequent process via a transfer roll 45. Next, the processes from “the first coating process” to “the completely curing process” are repeated multiple times as a subsequent process. Thus, multiple recording layers 11a and multiple intermediate layers 11b are alternately laminated on the protective sheet 31, forming a bulk layer 1 on the protective sheet 31. The final process may be to peel the protective sheet 31 from the bulk layer 1 and then wind the bulk layer 1 and the protective sheet 31 about different rolls.

Thus, the desired film-shaped bulk layer (a laminate for use in an optical information recording medium) is obtained.

### Third Embodiment

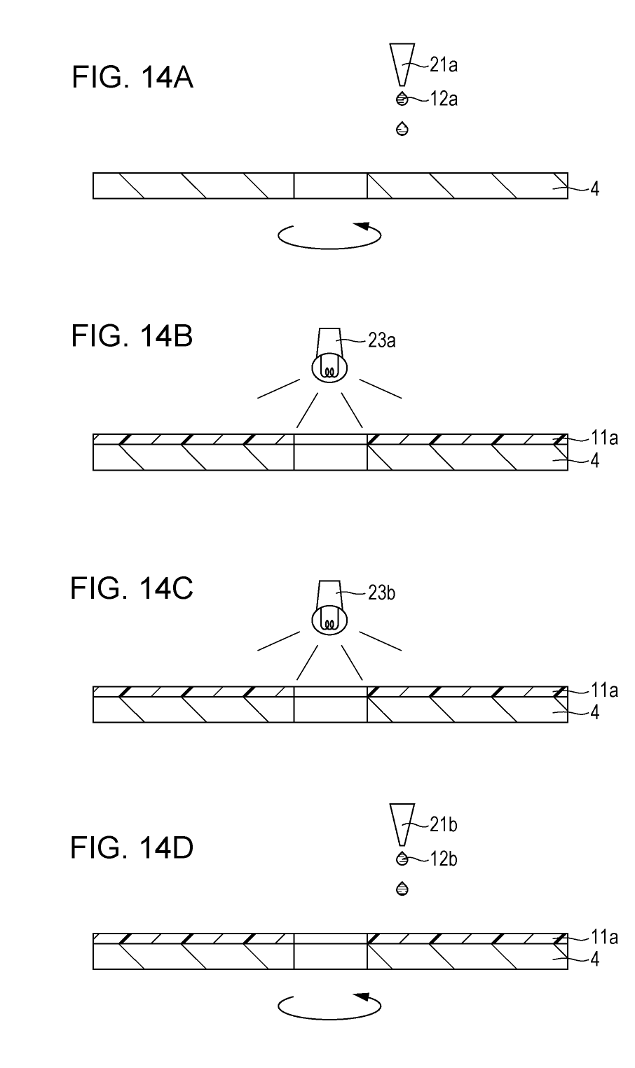

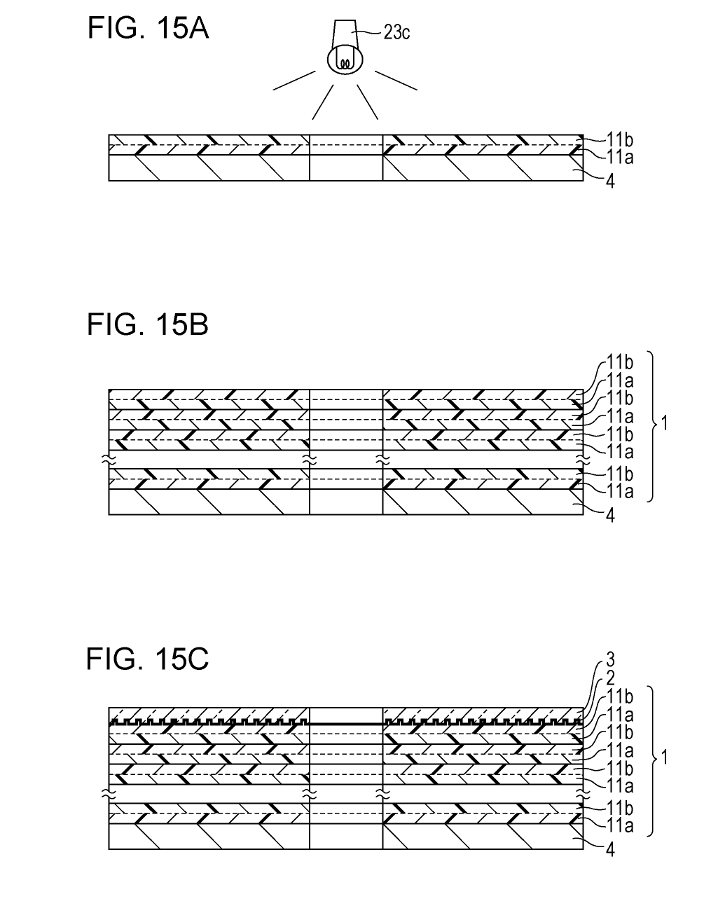

Referring now to FIGS. 14A to 15C, there will be described an example of a method for manufacturing an optical information recording medium 10 according to a third embodiment of the present application.

First Coating Process

First, as shown in FIG. 14A, a first resin composition 12a is dropped on the inside radius of a substrate 4 using an applicator 21a, and the first resin composition 12a dropped is stretched in the circumferential direction of the substrate 4 by spin coat to form a coating having a uniform thickness on the substrate 4. Examples of the first resin composition 12a include thermosetting resins and ultraviolet-curable resins. The resin composition that can be used in the present manufacturing method is not limited these and may be an energy beam-curable resin, thermoplastic resin, or the like other than ultraviolet-curable resins.

First Curing Process

Then, as shown in FIG. 14B, the coating made of the first resin composition 12a formed on the substrate 4 is cured by radiating an infrared ray or ultraviolet ray from a radiation source 23a. Thus, a recording layer 11a having a uniform thickness is formed on the substrate 4. Examples of the radiation source 23a for infrared radiation include IR lamps, and examples of the radiation source 23a for ultraviolet radiation include UV lamps. Examples of a UV lamp include high-pressure mercury-vapor lamps and flash UV/H bulbs.

Coating Process

Next, as shown in FIG. 14C, an oxide layer having linear absorption characteristics is formed on a surface of the recording layer 11a by radiating an ultraviolet ray from a radiation source 23b. The oxide layer has a concentration distribution in which the oxygen concentration continuously decreases from the surface of the layer along the thickness direction. The refractive index of this oxide layer continuously changes in the thickness direction. Examples of the radiation source 23b for ultraviolet ray application include high-pressure mercury-vapor lamps and UV lamps, such as flash UV/H bulbs. Note that the radiation power of the ultraviolet radiation from the radiation source 23b is set to a value greater than the radiation power of the ultraviolet radiation from the radiation source 23a.

Second Coating Process

Next, as shown in FIG. 14D, a second resin composition 12b is dropped on the inside radius of the substrate 4 using an applicator 21b, and the second resin composition 12b dropped is stretched in the circumferential direction of the substrate 4 by spin coat to form a coating having a uniform thickness on the recording layer 11a. Examples of the second resin composition 12b include thermosetting resins and ultraviolet-curable resins. The resin composition that can be used in the present manufacturing method is not limited these and may be an energy beam-curable resin, thermoplastic resin, or the like other than ultraviolet-curable resins.

Second Curing Process

Then, as shown in FIG. 15A, the coating made of the second resin composition 12b formed on the recording layer 11a is cured by radiating an infrared ray or ultraviolet ray from a radiation source 23c. Thus, the recording layer 11a and an intermediate layer 11b are formed on the substrate 4. Examples of the radiation source 22c for infrared radiation include IR lamps, and examples of the radiation source 22c for ultraviolet radiation include UV lamps.

Lamination Process

Next, the processes from “the first coating process” to “the second curing process” are repeated multiple times. Thus, as shown in FIG. 15B, multiple recording layers 11a and multiple intermediate layers 11b are alternately laminated, forming a bulk layer 1 on the substrate 4.

Next, as shown in FIG. 15C, a cover layer 3 having a selection reflective layer 2 thereon is bonded to one principal surface of the bulk layer 1 formed on the substrate 4. In this way, the desired optical information recording medium 10 is obtained.

In the optical information recording medium 10 thus manufactured, a recording mark is preferably formed on the interface between a recording layer 11a including the oxide layer, and an intermediate layer 11b. The reason is that since the oxide layer serves as a light absorption layer, a recording mark is easily formed.

### EXAMPLES

Hereafter, the present application will be specifically described using Examples. However, the present application is not limited thereto.

Examples and Test Examples will be described in the following order.

1. Consideration using sample (1)

2. Consideration using sample (2)

3. Consideration through simulation

1. Consideration Using Sample (1)

A sample having a refractive index that continuously changes in an interface and a sample having a refractive index which discontinuously changes in an interface were prepared, and the amount of reflected light was evaluated.

### Example 1

First, a glass substrate having a diameter of 120 mm and having a center hole having a diameter of 15 mm in the center thereof was prepared as a substrate. Next, an ultraviolet-curable acrylic resin B for recording layer formation was applied onto the glass substrate by spin coat to form a coating having a thickness of about 50 μm, and then the coating was semi-cured by radiating an ultraviolet ray of 0.37 J/cm² thereto. Thus, a semi-cured layer was formed on the glass substrate. The ultraviolet dose was set to 80% or less of the dose when completely curing the coating.

Next, an ultraviolet-curable acrylic resin A for resin thin film formation was applied onto the semi-cured layer by spin coat to form a coating having a thickness of about 2 μm. Thus, the ultraviolet-curable acrylic resin A for resin thin film formation and the semi-cured ultraviolet-curable acrylic resin B for recording layer formation were mutually dissolved on an interface a2. Next, by radiating an ultraviolet ray, the coating formed on the semi-cured layer was cured, and the semi-cured layer was completely cured. Thus, a recording layer and a resin thin film were formed on the glass substrate.

Next, there was prepared a 75 μm-thick polycarbonate film having a 25 μm-thick, colorless, transparent, adhesive resin layer C on one surface thereof and having a hole in the center thereof. Next, by bonding this film to the resin thin film via the adhesive layer, a cover layer was formed on the recording layer.

Note that the materials of the substrate, the recording layer, the resin thin film, and the adhesive layer were selected such that the difference in refractive index between the substrate and the recording layer was 0.05 or less; the difference in refractive index between the recording layer and the resin thin film was 0.1 or more; and the difference in refractive index between the resin thin film and the adhesive layer was 0.2 or more.

In this way, the desired optical information recording medium was obtained.

### Comparative Example 1

An optical information recording medium was obtained as in Example 1, except that a recording layer was formed on a glass substrate by applying an ultraviolet-curable acrylic resin B onto the glass substrate to form a coating and then radiating an ultraviolet ray to the coating to completely cure the coating.

Evaluation of Amounts of Reflected Light

The amounts of reflected light of the optical information recording media of Example 1 and Comparative Example 1 thus obtained were evaluated as follows. There was monitored the amount of reflected light when the optical information recording medium was rotated while regeneration light was focused on an interface a1 between the resin thin film A and the adhesive resin layer C. As a result, light amount variations regarded as having been caused by light reflected from the interface a2 were observed in Comparative Example 1. With respect to the above evaluation, it is believed that light reflected from the interface includes two types of reflected light, that is, light reflected from the interface a2 between the recording layer B and the resin thin film A and light reflected from the interface a1 between the resin thin film A and the adhesive resin layer C and that the two types of light reflected from the interfaces have caused the light amount variations. On the other hand, almost no light amount variations regarded as having been caused by interference between light reflected from the interfaces were observed in Example 1. The reason seems that while the difference in refractive index between the recording layer and the resin thin film is 0.1 or more in Example 1 as in Comparative Example 1, the refractive index continuously changes in the interface between the recording layer and the resin thin film and thus reflection of regeneration light from the interface between the recording layer and the resin thin film is reduced. Note that the continuous changes in refractive index in the interface between the recording layer and the resin thin film are believed to be made by the mutual dissolution of the materials of the recording layer and the resin thin film in that interface.

2. Consideration Using Sample (2)

Samples were prepared while changing the semi-cured state of the recording layer by adjusting the dose (cumulative amount of light), and the reflectance of light reflected from the interface between the recording layer and the resin thin film was evaluated.

### Example 2-1

The refractive indexes n of the recording layer and the resin thin film were adjusted within a range 1.65 to 1.72 and within a range of 1.45 to 1.5, respectively. The ultraviolet dose when forming a semi-cured layer was set to 40% or less of the dose when completely curing a coating. Except for the above conditions, an optical information recording medium was obtained as in Example 1.

### Example 2-2

Except that the ultraviolet dose when forming a semi-cured layer was set to 60% of the dose when completely curing a coating, an optical information recording medium was obtained as in Example 2-1.

### Example 2-3

Except that the ultraviolet dose when forming a semi-cured layer was set to 80% or more of the dose when completely curing a coating, an optical information recording medium was obtained as in Example 2-1.

Evaluation of Reflectance

With respect to the optical information recording media of Examples 2-1 to 2-3 thus obtained, the reflectance of light reflected from the interface between the recording layer and the resin thin film was evaluated. The evaluation results are shown in Table 1.

Table 1 shows the evaluation results of the optical information recording media of Examples 2-1 to 2-3.

TABLE 1

| | Dose [%] | Interface reflectance [%] |
|---|---|---|
| Example 2-1 | 40 or less | 0 |
| Example 2-2 | 60 | 0.16 |
| Example 2-3 | 80 or more | 0.5 |

Table 1 indicates that adjusting the dose to change the degree of cure of the ultraviolet-curable acrylic resin for recording layer formation causes changes in the reflectance of light reflected from the interface between the recording layer and the resin thin film. The reason seems that the adjustment of the dose caused changes in the mutual dissolution state in the interface and thus changed the refractive index of the interface.

3. Consideration Through Simulation

The transition region (interface) in which the refractive index continuously changes was modeled using a multilayer film in which the refractive index gradually changes; the number of layers of the multilayer film or the thickness of the multilayer film was changed; and the reflectance and transmittance were obtained through a simulation.

### Test Example 1-1

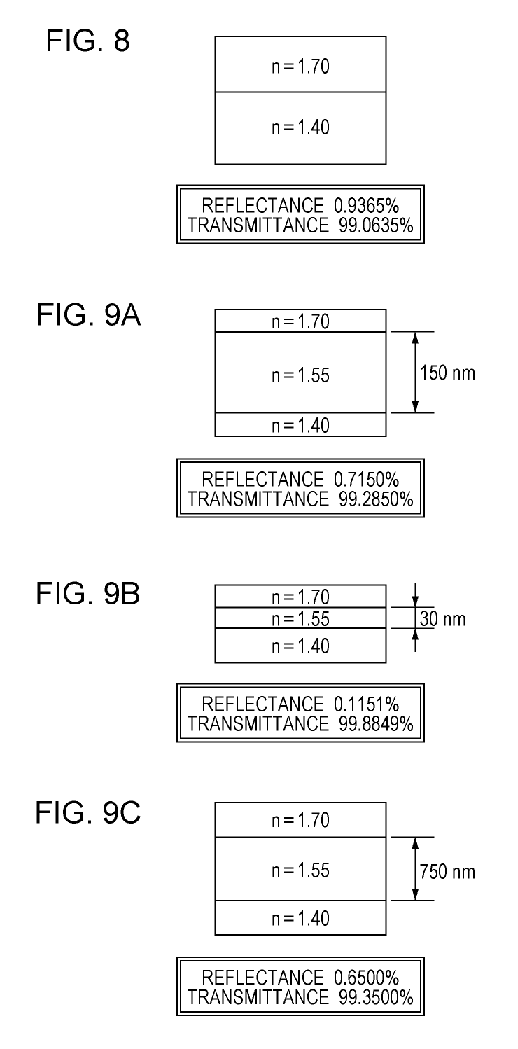

As shown in FIG. 8, a two-layer laminate in which the refractive index n increases in the thickness direction was modeled, and the reflectance and transmittance of this laminate were obtained through a simulation.

### Test Example 2-1

As shown in FIG. 9A, a three-layer laminate in which the refractive index n increases in the thickness direction was modeled, and the reflectance and transmittance of this laminate were obtained through a simulation.

### Test Example 2-2

As shown in FIG. 9B, except that the thickness of a layer whose refractive index n was 1.55 was reduced to 30 nm, the reflectance and transmittance of a laminate was obtained through a simulation as in Test Example 2-1.

### Test Example 2-3

As shown in FIG. 9C, except that the thickness of a layer whose refractive index n was 1.55 was increased to 750 nm, the reflectance and transmittance of a laminate was obtained through a simulation as in Test Example 2-1.

### Test Example 3-1

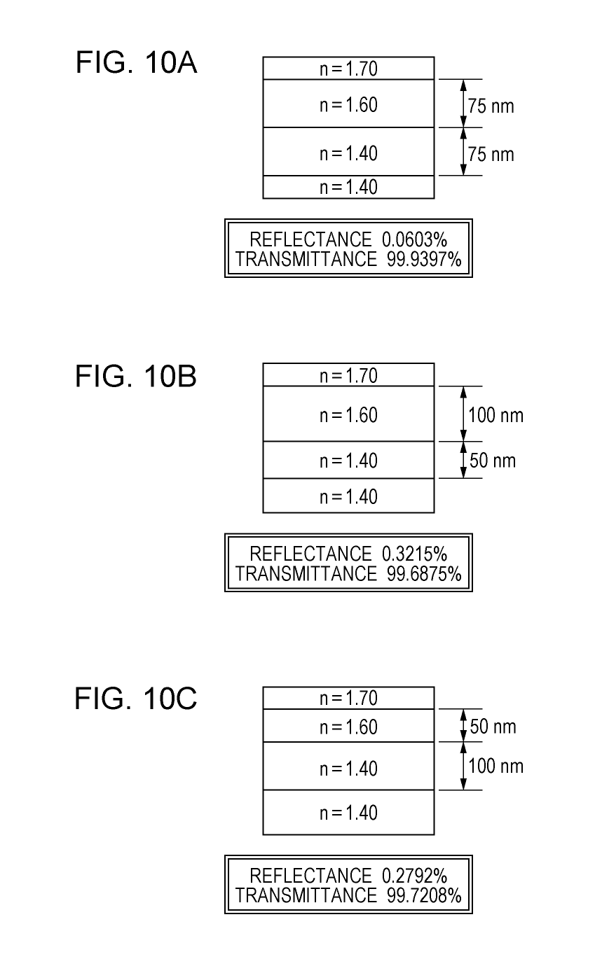

As shown in FIG. 10A, a four-layer laminate in which the refractive index n increases in the thickness direction was modeled, and the reflectance and transmittance of this laminate were obtained through a simulation.

### Test Example 3-2

As shown in FIG. 10B, except that the thickness of a layer whose refractive index n was 1.40 was reduced to 50 nm and that the thickness of a resin layer whose refractive index n was 1.60 was increased to 100 nm, the reflectance and transmittance of a laminate was obtained through a simulation as in Test Example 3-1.

### Test Example 3-3

As shown in FIG. 10C, except that the thickness of a layer whose refractive index n was 1.40 was increased to 100 nm and that the thickness of a resin layer whose refractive index n was 1.60 was reduced to 50 nm, the reflectance and transmittance of a laminate was obtained through a simulation as in Test Example 3-1.

### Test Example 4-1

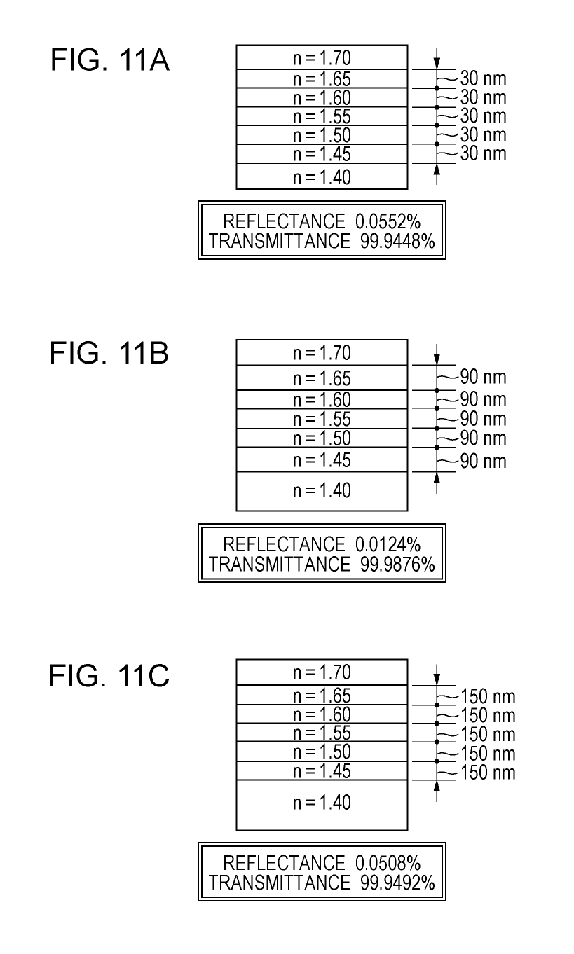

As shown in FIG. 11A, a seven-layer laminate in which the refractive index n increases in the thickness direction was modeled, and the reflectance and transmittance of this laminate were obtained through a simulation.

### Test Example 4-2

As shown in FIG. 11B, except that the thickness of layers whose refractive index n was 1.45 to 1.65 was increased to 90 nm, the reflectance and transmittance of a laminate was obtained through a simulation as in Test Example 4-1.

### Test Example 4-3

As shown in FIG. 11C, except that the thickness of layers whose refractive index n was 1.45 to 1.65 was increased to 150 nm, the reflectance and transmittance of a laminate was obtained through a simulation as in Test Example 4-1.

### Test Example 5-1

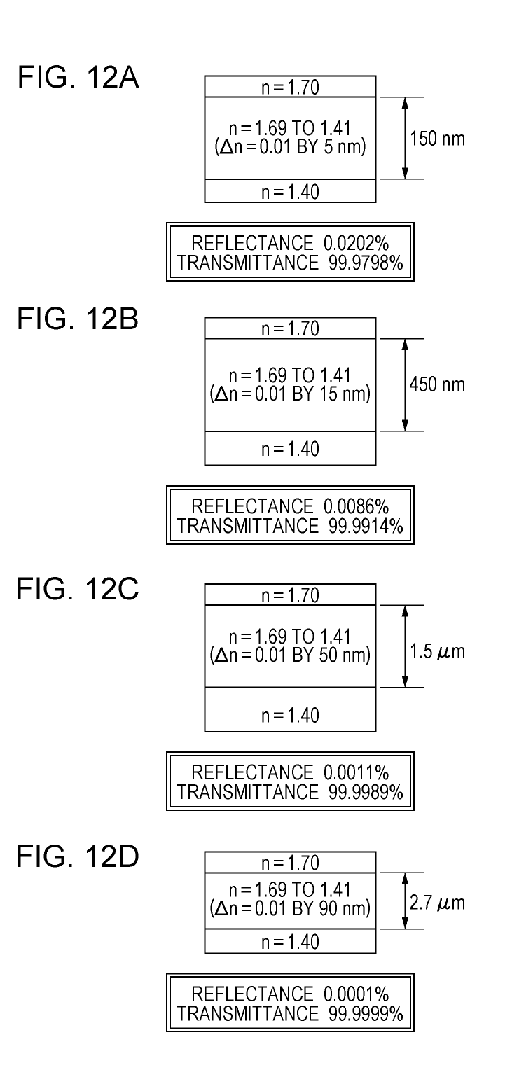

As shown in FIG. 12A, a laminate in which the refractive index n increases in the thickness direction was modeled, and the reflectance and transmittance of this laminate were obtained through a simulation. Note that layers whose refractive index n was 1.69 to 1.41 constitute a multilayer film having a total thickness of 150 nm in which the refractive index n increases by 0.01 for every 5-nm thickness increase.

### Test Example 5-2

As shown in FIG. 12B, except that layers whose refractive index n was 1.69 to 1.41 constitute a multilayer film having a total thickness of 450 nm in which the refractive index n increases by 0.01 for every 15-nm thickness increase, the reflectance and transmittance of a laminate was obtained through a simulation as in Test Example 5-1.

### Test Example 5-3

As shown in FIG. 12C, except that layers whose refractive index n was 1.69 to 1.41 constitute a multilayer film having a total thickness of 1.5 μm in which the refractive index n increases by 0.01 for every 50-nm thickness increase, the reflectance and transmittance of a laminate was obtained through a simulation as in Test Example 5-1.

### Test Example 5-4

As shown in FIG. 12D, except that layers whose refractive index n was 1.45 to 1.65 constitute a multilayer film having a total thickness of 2.7 μm in which the refractive index n increases by 0.01 for every 90-nm thickness increase, the reflectance and transmittance of a laminate was obtained through a simulation as in Test Example 5-1.

### Test Example 5-5

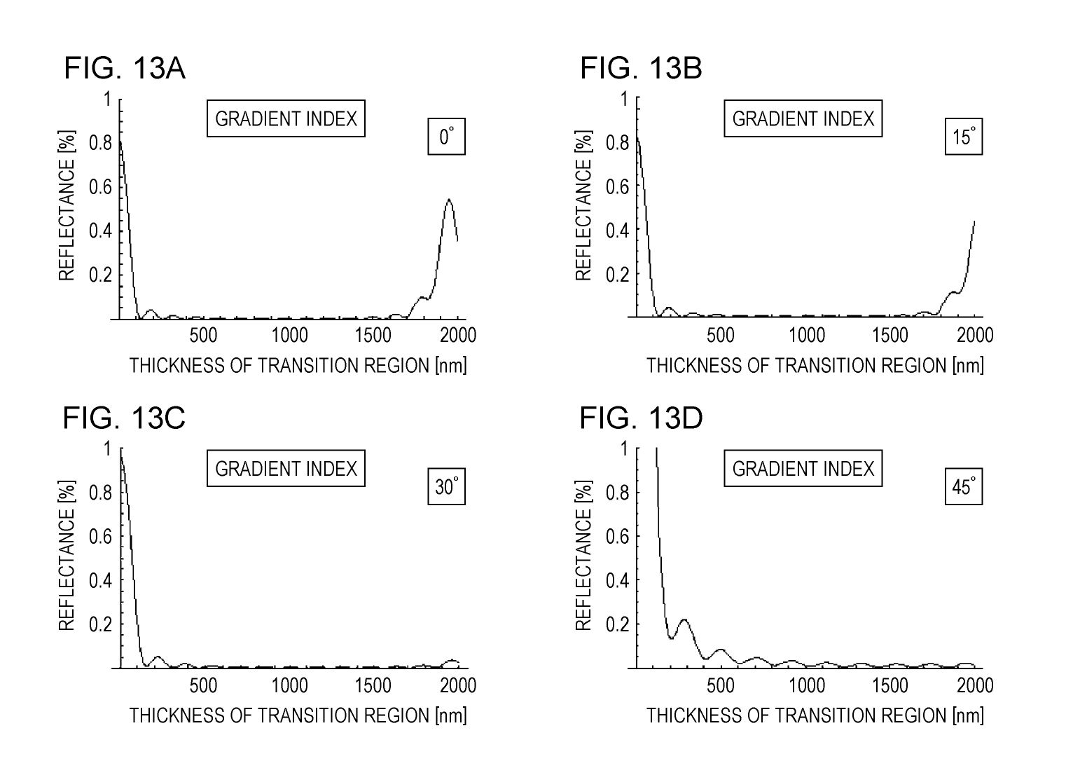

FIGS. 13A to 13D show graphs having a horizontal axis which represents the thickness of the transition region in an interface structure in which the refractive index gradually changes from 1.4 to 1.7 and a vertical axis which represents the reflectance from the interface structure when the incident angle of light having a wavelength of 400 nm was 0°, 15°, 30°, and 45°. Assuming that the refractive index monotonously increases by 0.02 for every one-fifteenth of the thickness of the transition region, calculations were made.

Among the results of the above simulations, reflectances and transmittances obtained when light having a wavelength of 400 nm was vertically incident on the laminate from a layer whose refractive index n was 1.40 are typically shown in FIGS. 8 to 12D.

FIGS. 13A to 13D indicate that when the incident angle of light was about 30° or less and when the width of the region between a layer whose refractive index n is 1.40 and a layer whose refractive index n is 1.70 (hereafter referred to as “the transition region”) is about 100 nm or more, sufficient reflectance reduction effects can be obtained.

As the number of layers forming the transition region increases, that is, as changes in the refractive index of the transition region become smoother, the reflectance can be reduced and the transmittance can be increased.

The periodicity of the reflectance due to the thickness of the transition region tends to decrease as the number of layers of the transition region increases.

Accordingly, by gradually changing the refractive index of the interface between the resin layers in the thickness direction of the resin layers, it is possible to reduce reflection from the interface between the resin layers, as well as to increase the transmittance between the resin layers.

When the mutual dissolution of resins of different types in the transition region is not so good, a micro-domain structure (a structure including geometrically convoluted micro-regions) may be formed. As the transition region becomes larger in the thickness direction of the film, the micro-domain size in the interface also becomes larger. This may be detected as an optical change, acting as noise. Considering the size of regeneration light spot according to the present application, a preferred upper limit of the transition region is about 1 μm.

While the embodiments of the present application have been described specifically, the present application is not limited thereto. Various modifications can be made thereto as long as the modifications are based on the technical idea of the present application.

For example, the structures, methods, processes, shapes, materials, numerical values, and the like used in the embodiments are illustrative only, and structures, methods, processes, shapes, materials, numerical values, and the like different from these may be used as necessary.

Further, the structures, methods, processes, shapes, materials, numerical values, and the like in the embodiments may be combined without departing from the spirit of the present application.

The number of types of resin layers forming a bulk layer (laminate) is not limited to two, and three or more types of resin layers may be combined to form a bulk layer.

Further, according to the present application, if it is desired to suppress optical reflection from any interface of interfaces formed by laminating multiple resin layers having different refractive indexes, it is possible to continuously change the refractive index in that interface. Accordingly, the combination of refractive indexes is not limited to the exemplified combination “high-refractive-index layer/low-refractive-index layer . . . high-refractive-index layer/low-refractive-index layer,” and a modification as described below is also possible: by further incorporating a thin high-refractive-index layer B and a thin low-refractive-index layer B into the multilayer structure, there is made a combination a combination “high-refractive-index layer A/high-refractive-index layer B/low-refractive-index layer A/low-refractive-index layer B/high-refractive-index layer A/high-refractive-index layer B . . . high-refractive-index layer A/high-refractive-index layer B/low-refractive-index layer A/low-refractive-index layer B”; and in the above combination, the refractive index is continuously changed between the high-refractive-index layers A and B, between the low-refractive-index layers A and B, and between the low-refractive-index layer B and the high-refractive-index layer A, as necessary, to suppress interface reflection, and interface reflection is caused only between the high-refractive-index layer B and the low-refractive-index layer A. Further, the present application, which suppresses interface reflection caused by any interface, is also applicable to a structure in which the periodicity of the multilayer structure is eliminated from the above example.

The present application may be configured as follows:

(1) An optical information recording medium including a plurality of laminated resin layers, wherein at least one of interfaces between the resin layers has a refractive index which gradually changes in a thickness direction of the resin layers.
(2) The optical information recording medium according to (1), wherein the refractive index continuously changes.
(3) The optical information recording medium according to any one of (1) and (2), wherein the resin layers are a plurality of intermediate layers and a plurality of recording layers, and the intermediate layers and the recording layers are alternately disposed.
(4) The optical information recording medium according to (3), wherein of interfaces on both sides of each of the recording layers, one interface has a continuously changing refractive index, while the other interface has a discontinuously changing refractive index.
(5) The optical information recording medium according to any one of (3) and (4), wherein the other interface is configured such that a recording mark can be formed thereon.
(6) The optical information recording medium according to any one of (3) to (5), wherein an average thickness of the recording layers falls within a range of 30 nm or more and 5 μm or less.
(7) The optical information recording medium according to any one of (1) to (6), wherein two resin layers forming the interface having the gradually changing refractive index are mutually dissolved in the interface.
(8) The optical information recording medium according to any one of (1) to (7), wherein each of the resin layers contains one of an ultraviolet-curable resin and a thermosetting resin as a main ingredient.
(9) The optical information recording medium according to any one of (1) to (3), wherein the interfaces between the resin layers are configured such that a recording mark can be formed thereon.
(10) A laminate for use in an optical information recording medium, including: a plurality of laminated resin layers, wherein interfaces between the resin layers are configured such that a recording mark can be formed thereon, and wherein at least one of the interfaces between the resin layers has a refractive index which gradually changes in a thickness direction of the resin layers.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An optical information recording medium comprising:
a plurality of laminated resin layers,
wherein at least one of interfaces between the resin layers has a refractive index which gradually changes in a thickness direction of the resin layers.

2. The optical information recording medium according to claim 1, wherein the refractive index continuously changes.

3. The optical information recording medium according to claim 1, wherein the resin layers are a plurality of intermediate layers and a plurality of recording layers, and the intermediate layers and the recording layers are alternately disposed.

4. The optical information recording medium according to claim 3, wherein of interfaces on both sides of each of the recording layers, one interface has a continuously changing refractive index, while the other interface has a discontinuously changing refractive index.

5. The optical information recording medium according to claim 3, wherein the other interface is configured such that a recording mark can be formed thereon.

6. The optical information recording medium according to claim 3, wherein an average thickness of the recording layers falls within a range of 30 nm or more and 5 μm or less.

7. The optical information recording medium according to claim 1, wherein two resin layers forming the interface having the gradually changing refractive index are mutually dissolved in the interface.

8. The optical information recording medium according to claim 1, wherein each of the resin layers contains one of an ultraviolet-curable resin and a thermosetting resin as a main ingredient.

9. The optical information recording medium according to claim 1, wherein the interfaces between the resin layers are configured such that a recording mark can be formed thereon.

10. A laminate for use in an optical information recording medium, comprising:
a plurality of laminated resin layers,
wherein interfaces between the resin layers are configured such that a recording mark can be formed thereon, and
wherein at least one of the interfaces between the resin layers has a refractive index which gradually changes in a thickness direction of the resin layers.
